(19) United States
(12) Patent Application Publication
(10) Pub. No.: US 2025/0055538 A1
(43) Pub. Date: Feb. 13, 2025

(54) CSI-RS TRANSMISSION

(71) Applicant: Nokia Technologies Oy, Espoo (FI)

(72) Inventors: Lei DU, Beijing (CN); Mads LAURIDSEN, Gistrup (DK); Bahram KHAN, Aalborg (DK); Daniela LASELVA, Klarup (DK)

(21) Appl. No.: 18/797,231

(22) Filed: Aug. 7, 2024

Related U.S. Application Data
(63) Continuation of application No. PCT/CN2023/112378, filed on Aug. 10, 2023.

(51) Int. Cl. H04B 7/06; H04W 76/28

(52) U.S. Cl. CPC H04B 7/0626; H04B 7/06964; H04W 76/28

(57) ABSTRACT

Example embodiments of the present disclosure relate to apparatuses, methods, devices, and computer readable storage medium for a transmission of a channel state information reference signal (CSI-RS). In a method, a first apparatus receives, from a second apparatus, a configuration of discontinuous transmission (DTX) of the second apparatus. The first apparatus transmits, to the second apparatus, a request for a transmission of a CSI-RS during at least one non-active period of the DTX.

### FIELDS

Various example embodiments of the present disclosure generally relate to the field of telecommunication and in particular, to apparatuses, methods, devices, and computer readable storage medium for a transmission of a channel state information reference signal (CSI-RS) in a discontinuous transmission (DTX) mode.

### BACKGROUND

In Release 18 (Rel-18), a work item on network energy saving (NES) is being studied. The work item contains the following objective on cell DTX: specifying enhancement on cell DTX and discontinuous reception (DRX) mechanism including the alignment of cell DTX/DRX and user equipment (UE) DRX in radio resource control (RRC)_CONNECTED mode, and inter-node information exchange on cell DTX/DRX. There is no change for Synchronization signal block (SSB) transmission due to cell DTX/DRX. The impact to IDLE/INACTIVE UEs due to the above enhancement needs to be avoided.

### SUMMARY

In a first aspect of the present disclosure, there is provided a first apparatus. The first apparatus comprises at least one processor; and at least one memory storing instructions that, when executed by the at least one processor, cause the first apparatus at least to: receive, from a second apparatus, a configuration of discontinuous transmission (DTX) of the second apparatus; and transmit, to the second apparatus, a request for a transmission of a channel state information reference signal (CSI-RS) during at least one non-active period of the DTX.

In a second aspect of the present disclosure, there is provided a second apparatus. The second apparatus comprises at least one processor; and at least one memory storing instructions that, when executed by the at least one processor, cause the second apparatus at least to: transmit, to a first apparatus, a configuration of discontinuous transmission (DTX) of the second apparatus; and receive, from the first apparatus, a request for a transmission of a channel state information reference signal (CSI-RS) during at least one non-active period of the DTX.

In a third aspect of the present disclosure, there is provided a method at a first apparatus. The method comprises: receiving, from a second apparatus, a configuration of discontinuous transmission (DTX) of the second apparatus; and transmitting, to the second apparatus, a request for a transmission of a channel state information reference signal (CSI-RS) during at least one non-active period of the DTX.

In a fourth aspect of the present disclosure, there is provided a method at a second apparatus. The method comprises: transmitting, to a first apparatus, a configuration of discontinuous transmission (DTX) of the second apparatus; and receiving, from the first apparatus, a request for a transmission of a channel state information reference signal (CSI-RS) during at least one non-active period of the DTX.

In a fifth aspect of the present disclosure, there is provided a first apparatus. The first apparatus comprises means for receiving, from a second apparatus, a configuration of discontinuous transmission (DTX) of the second apparatus; and means for transmitting, to the second apparatus, a request for a transmission of a channel state information reference signal (CSI-RS) during at least one non-active period of the DTX.

In a sixth aspect of the present disclosure, there is provided a second apparatus. The second apparatus comprises means for transmitting, to a first apparatus, a configuration of discontinuous transmission (DTX) of the second apparatus; and means for receiving, from the first apparatus, a request for a transmission of a channel state information reference signal (CSI-RS) during at least one non-active period of the DTX.

In a seventh aspect of the present disclosure, there is provided a computer readable medium. The computer readable medium comprises instructions stored thereon for causing an apparatus to perform at least the method according to the third or fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling diagram for an example communication process 200 between the first apparatus and the second apparatus according to some example embodiments of the present disclosure;

FIG. 3 illustrates a signaling diagram of a process for CSI-RS transmission according to some example embodiment of the present disclosure;

FIG. 4 illustrates a flow chart of a process implemented at the first apparatus 110 according to some example embodiments of the present disclosure;

FIG. 5 illustrates a flowchart of a method implemented at a first apparatus according to some example embodiments of the present disclosure;

FIG. 6 illustrates a flowchart of a method implemented at a second apparatus according to some example embodiments of the present disclosure;

FIG. 7 illustrates a simplified block diagram of a device that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

In a CSI-RS based beam failure detection procedure, if cell DTX is used, the CSI-RS transmissions and related measurements and beam-based mobility may be impacted by the cell DTX. From RAN1 point of view, there are the following candidate signals/channels for connected mode UEs, which the UE may be expected to not transmit or receive during non-active periods of cell DTX/DRX: Periodic or Semi-persistent (SPS) CSI-RS (including tracking reference signal (TRS)) configured in CSI report configuration in CSI-ReportConfig with reportQuantity (for CSI reporting), positioning reference signal (PRS), a physical downlink control channel (PDCCH) scrambled with UE specific Radio Network Temporary Identifier (RNTI), a PDCCH in Type-3 common search space (CSS), and a SPS physical downlink shared channel (SPS-PDSCH) for downlink (DL), and scheduling request (SR), a Periodic/Semi-persistent CSI report, a Periodic/Semi-persistent sounding reference signal (SRS), and configured grant physical uplink shared channel (CG-PUSCH) for uplink (UL). Other signals/channels are not precluded.

The exact set of signals/channels that the UE may be expected to not transmit or receive is for further study. It is also for further study whether the list of impacted signals/channels can be configurable, and whether there will be exception case(s) for UE receiving and/or processing listed signals/channels during non-active periods of DTX.

From RAN2 point of view for Cell DTX/DRX configuration and activation/deactivation, it is agreed that a periodic cell DTX/DRX configuration is explicitly signaled to the UEs. One or more periodic cell DTX/DRX patterns may be configured by UE specific RRC signaling. The Cell DTX/DRX configuration contains at least: periodicity, start slot/offset, on duration. Cell DTX/DRX may be activated/deactivated explicitly by L1 (i.e. DCI) signaling, i.e., activated or deactivated immediately once receiving the L1 signaling. Alternatively, Cell DTX/DRX may be activated/deactivated implicitly by RRC signaling, i.e., activated immediately once configured by RRC and deactivated once the RRC configuration is released.

Network energy saving can be achieved by skipping the CSI-RS transmissions during non-active time/periods of cell DTX. However, such skipping will impact the UE measurement performance and particularly the ability to detect beam failures whenever beam failure detection based on CSI-RS is configured. There needs a trade-off between skipping some CSI-RS transmissions to save network energy and transmitting some CSI-RS to facilitate the beam-based mobility during non-active time of cell DTX.

In the beam failure detection (BFD) and recovery procedures in 5G NR, the UE detects Beam Failure if layer 1 reference signal received power (L1-RSRP) for the connected beam is below a certain threshold. The UE uses the configured Reference Signal to detect the beam failure (e.g., CSI-RS that can be configured with BFR-CSIRS-Resource IE or SSB with BFR-SSB-Resource IE as specified in the 3GPP standards such as TS 38.331). The related measurement requirements are defined in TS 38.133 as follows.

The UE needs to assess the downlink radio link quality of a serving cell based on the reference signal in the set q̅₀ as specified in TS 38.213. To detect beam failure on: PCell in SA operation mode, PSCell in EN-DC operation mode, and PSCell in NR-DC operation mode, the RS resource configurations in the set q̅₀ on PCell, PSCell or deactivated PSCell (if configured with bfd-and-RLM with value true) can be periodic CSI-RS resources and/or SSBs. RS resource configuration in the set q̅₀ on SCell shall be periodic CSI-RS. UE is not required to perform beam failure detection outside the active DL BWP. On each RS resource configuration the set q̅₀, the UE shall estimate the radio link quality and compare it to the threshold Q_{out_LR} for the purpose of accessing downlink radio link quality of the serving cell beams.

Upon request the UE delivers configuration indexes from the set q̅₁ as specified in TS 38.213. The UE applies the Qin LR threshold to the L1-RSRP measurement obtained for a CSI-RS resource after scaling a respective CSI-RS reception power with a value provided by higher layer parameter powerControlOffsetSS. The RS resource configurations in the set q̅₁ can be periodic CSI-RS resources or SSBs or both SSB and CSI-RS resources. It is observed that the primary cell (PCell) and primary secondary cell (PSCell) may in principle skip CSI-RS transmissions because the UE can rely on the SSB transmitted by these cells. However, for the secondary cell (SCell), the UE can use only the periodic CSI-RS and thus UE cannot fallback to measure SSB.

Moreover, the UE needs to be able to evaluate whether the downlink radio link quality on the CSI-RS resource in set 4% estimated over the last T_{Evaluate_BFD_CSI-RS} MS period becomes worse than the threshold Q_{out_LR_CSI-RS} within T_{Evaluate_BFD_CSI-RS} ms period. The value of T_{Evaluate_BFD_CSI-RS} is defined in Table 8.5.3.2-1 or Table 8.5.3.2-3 (deactivated PSCell) for FR1. The value of T_{Evaluate_BFD_CSI-RS} is defined in Table 8.5.3.2-2 or Table 8.5.3.2-4 as below.

TABLE 8.5.3.2-1
Evaluation period T_{Evaluate}_{_{—}}_{BFD}_{_{—}}_{CSI-RS} for FR1

| Configuration | T_{Evaluate}_{_{—}}_{BFD}_{_{—}}_{CSI-RS} (ms) |
|---|---|
| no DRX | Max(50, Ceil(M_{BFD} × P × P_{BFD}) × T_{CSI-RS}) |
| DRX cycle ≤ 320 ms | Max(50, Ceil(1.5 × M_{BFD} × P × P_{BFD}) × |
| | Max(T_{DRX}, T_{CSI-RS})) |
| DRX cycle > 320 ms | Ceil(M_{BFD} × P × P_{BFD}) × T_{DRX} |

Note:
T_{CSI-RS} is the periodicity of CSI-RS resource in the set q̅₀. T_{DRX} is the DRX cycle length.

TABLE 8.5.3.2-2
Evaluation period T_{Evaluate}_{_{—}}_{BFD}_{_{—}}_{CSI-RS} for FR2

| Configuration | T_{Evaluate}_{_{—}}_{BFD}_{_{—}}_{CSI-RS} (ms) |
|---|---|
| no DRX | Max(50, Ceil(M_{BFD} × P × N × P_{BFD}) × |
| | T_{CSI-RS}) |
| DRX cycle ≤ 320 ms | Max(50, Ceil(1.5 × M_{BFD} × P × N × P_{BFD}) × |
| | Max(T_{DRX}, T_{CSI-RS})) |
| DRX cycle > 320 ms | Ceil(M_{BFD} × P × N × P_{BFD}) × T_{DRX} |

Note:
T_{CSI-RS} is the periodicity of CSI-RS resource in the set q̅₀. T_{DRX} is the DRX cycle length.

As discussed above, the 3GPP specification (e.g., TS 38.133) defines that the UE needs to assess the downlink radio link quality of a serving cell based on the reference signal in order to detect beam failure on SCell. However, there is an issue how the UE handles CSI-RS based measurements (in particular for SCell and for BFD) if such CSI reference signals are skipped by the SCell during cell DTX non-active periods and the UE cannot use SCell's SSB since this is not defined as a reference signal resource for BFD on Scell.

Example embodiments of the present disclosure propose a CSI-RS transmission scheme. This scheme allows an apparatus (referred to as a first apparatus) such as a UE to request another apparatus (referred to as a second apparatus) such as a gNB configured with DTX, to transmit a CSI-RS during one or more non-active periods of DTX of another device. The first apparatus can receive a configuration of DTX from the second apparatus. Thus, the first apparatus may know that the CSI-RS are not transmitted during the non-active periods. By requesting the CSI-RS transmission, the impact on CSI-RS measurements during cell DTX inactive or non-active time may be avoided if the first apparatus has determined the need for the additional CSI-RS. Moreover, the network may save energy by only transmitting the CSI-RS during non-active time when the CSI-RS are actually needed by the first apparatus.

It is to be noted that although the issue is originating from SCell, the proposed scheme herein may be applied in general for any type of serving cells including a PCell, PScell and a SCell. In the following, some example embodiments will be described using a SCell as an example while the example embodiments herein can be applied in general for a PSCell and other serving cells.

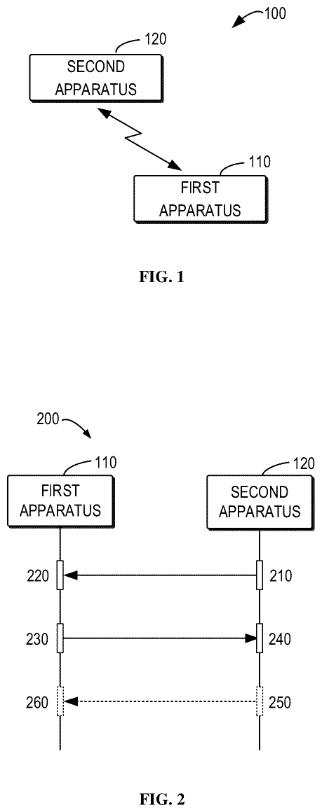

FIG. 1 illustrates an example communication environment 100 in which example embodiments of the present disclosure can be implemented. In the communication environment 100, a first apparatus 110 and a second apparatus 120 can communicate with each other. In some example embodiments, the first apparatus 110 may operate as a terminal device, and the second apparatus 120 may operate as a network device serving the terminal device in one or more cells.

In the following, for the purpose of illustration, some example embodiments are described with the first apparatus 110 operating as a terminal device and the second apparatus 120 operating as a network device. However, in some example embodiments, operations described with respect to a terminal device may be implemented at a network device or other devices, and operations described with respect to a network device may be implemented at a terminal device or other devices.

In some example embodiments, if the first apparatus 110 is a terminal device and the second apparatus 120 is a network device, a link from the second apparatus 120 to the first apparatus 110 is referred to as a DL, while a link from the first apparatus 110 to the second apparatus 120 is referred to as an uplink (UL). In DL, the second apparatus 120 is a transmitting (TX) device (or a transmitter), and the first apparatus 110 is a receiving (RX) device (or a receiver). In UL, the first apparatus 110 is a TX device (or a transmitter), and the second apparatus 120 is a RX device (or a receiver). If both the first apparatus 110 and the second apparatus 120 are terminal devices, a link between two terminal devices is referred to as a sidelink (SL). In SL, one of the first and second apparatuses 110 and 120 is a TX device (or a transmitter), and the other of the first and second apparatuses 110 and 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

It is to be understood that the number of apparatuses is shown in FIG. 1 only for the purpose of illustration without suggesting any limitation. The communication environment 100 may include any suitable number of apparatuses configured to implement example embodiments of the present disclosure.

In the communication environment 100, the second apparatus 120 is configured with DTX. In some example embodiments, DTX may configured for a cell such as SCell. Such DTX may be also called cell DTX. The first apparatus 110 may be aware of the cell DTX pattern of its serving SCell based on a configuration of DTX from the second apparatus 120. The first apparatus 110 may know that a CSI-RS are not transmitted during the non-active periods of cell DTX (also called cell DTX non-active periods). In some example embodiments, the CSI-RS may be configured for BFD measurements. Alternatively, the CSI-RS may be configured for other purposes.

In various example embodiments, the first apparatus 110 can trigger a request for a transmission of CSI-RS (associated with BFD) during one or more cell DTX non-active periods. This trigger can be based on the observed or estimated radio power/quality level or any implementation-based reason for triggering. As such, dropping/skipping transmissions of the CSI-RS configured for BFD during a cell DTX non-active period may be addressed.

FIG. 2 shows a signaling diagram for an example communication process 200 between the first apparatus 110 and the second apparatus 120 according to some example embodiments of the present disclosure.

As shown in FIG. 2, the second apparatus 120 transmits (210) a configuration of DTX of the second apparatus 120 to the first apparatus 110. In some example embodiments, the configuration may be a DTX pattern. In an example, the first apparatus 110 may be configured with CSI-RS based BFD and the first apparatus 110 may be assumed to only measure BFD-CSI-RS during the cell DTX active periods when cell DTX is activated.

After the first apparatus 110 receives (220) this configuration, the first apparatus 110 may determine that a CSI-RS needs to be measured during a non-active period of the DTX. Then, the first apparatus 110 transmits (230) to the second apparatus, a request for the transmission of the CSI-RS during one or more non-active periods of the DTX.

In some example embodiments, the transmitting of the request may be triggered by at least one condition and/or based on measurements of the CSI-RS (also referred to as CSI-RS measurements). In some example embodiments, if the first apparatus 110 determines, based on measurements of the CSI-RS, that at least one condition is met, the first apparatus 110 may determine that the transmission of the CSI-RS is needed during the at least one non-active period of the DTX. Then, the first apparatus 110 may transmit, to the second apparatus 120, the request for the transmission of the CSI-RS during the at least one non-active period of the DTX.

In some example embodiments, the at least one condition may comprise a condition that a measured quality metric of the CSI-RS is equal to or less than a threshold quality metric. The quality metric of the CSI-RS may be measured in any suitable measurement approach which may be reference signal received power (RSRP), reference signal received quality (RSRQ), Signal to Interference plus Noise Ratio (SINR) and/or the like. The quality metric may reflect radio channel quality, radio power, radio quality, and/or the like. In an example, the condition may comprise a condition that the radio channel quality, radio power and/or radio quality (e.g., layer 1 RSRP (L1-RSRP)) is below a (network configured) threshold.

Alternatively, or in addition, the condition may comprise a condition that a quality metric of the CSI-RS is equal to or less than a threshold quality metric within a time window. In an example, the time window may be duration of the DTX non-active period. For example, the condition may comprise a condition that the radio power/quality is below or within a (network configured) threshold within a (network configured) time window (e.g., during the cell DTX non-active period). As an example, the first apparatus 110 may determine whether a value of the CSI-RS measurement result is below a threshold or whether the variation of the CSI-RS measurement results is within a range.

Alternatively, or in addition, the condition may comprise a condition that a radio link quality metric on at least one of a plurality of resources for the CSI-RS is equal to or less than a threshold quality metric. In an example, the condition may comprise a condition that the downlink radio link quality on at least one of (or a certain number of) the CSI-RS resources in set q̅₀ is below a threshold e.g., Q_{out_LR_CSI-RS}. The above thresholds for determining whether one or more conditions are satisfied may be configured by network or the second apparatus 120, or set by the first apparatus 110 itself, e.g., based on previous CSI-RS measurements.

Alternatively, or in addition, the condition may comprise a condition that an additional measurement sample is required for the measurements of the CSI-RS. Alternatively, or in addition, the condition may comprise a condition that a beam failure instance indication is sent to high layers at the first apparatus 110. Alternatively, or in addition, the request may be triggered by implementation of the first apparatus 110 e.g., based on radio measurements, power levels and/or the like.

The first apparatus 110 may monitor and determine if one or more of the above conditions (e.g., prior to the end of a cell DTX active period) are met. If any of the conditions is met, the first apparatus 110 may indicate it to the second apparatus 120 a request of (ad-hoc) CSI-RS transmission during the non-active period(s). Alternatively, or in addition, the request may be indicated prior to the end of the cell DTX active period.

In some example embodiments, the first apparatus 110 may transmit, to the second apparatus 120, the request during an active period of discontinuous reception (DRX) of the second apparatus 120. In an example, the indication may be sent during active periods of cell DRX if configured. Alternatively, the transmission of the request is allowed irrespective of cell DRX status e.g., it may also be sent during non-active periods of cell DRX.

In some example embodiments, the first apparatus 110 may also report the outcome of the determining to the second apparatus 120. The report can be complemented with the request. The request may include a measurement status of BFD on a plurality of resources for the CSI-RS. In an example, the request may include BFD measurement status of the CSI-RS resources e.g., if the downlink radio link quality is below a threshold on each of the CSI-RS resources (i.e., the outcome of the determination of the conditions described above). In another example, the request may include BFD measurement result of the CSI-RS resources.

Alternatively, or in addition, the request may include an indication of at least one resource for the transmission of the CSI-RS during the at least one non-active period of the DTX such as a CSI-RS resource index. The first apparatus 110 may request which CSI-RS(s) for BFD are expected to be transmitted during the non-active period(s) of cell DTX. In an example, it can be a bitmask indicating which CSI-RS resources in set q̅₀ is expected. Alternatively, the first apparatus 110 may request new CSI-RS(s) for BFD are expected to be transmitted during the non-active period(s) of cell DTX.

Alternatively, or in addition, the request may include an indication of a time period for the transmission of the CSI-RS during the at least one non-active period of the DTX. The first apparatus 110 may further request for the CSI-RS transmission for a certain time period. This can also be formulated as a number of CSI-RSs, or CSI-RS periodicity, or a number of cell DTX periodicity etc. In one option, a fixed (or default) time period can be predefined e.g. the time period for BFD evaluation.

Alternatively, or in addition, the request may include a number of CSI-RSs to be transmitted during the at least one non-active period of the DTX, or a number of non-active periods or DTX periodicity for the transmission of the CSI-RS during the at least one non-active period of the DTX. Alternatively, or in addition, the request may include an indication that the transmission of the CSI-RS during the at least one non-active period of the DTX is needed. For example, the first apparatus 110 may use flag/information to indicate the need for CSI-RS for BFD measurements during the cell DTX non-active period.

In some example embodiments, as shown in FIG. 2, after the second apparatus 120 receives (240) a request for the transmission of the CSI-RS during the at least one non-active period of the DTX, the second apparatus 120 may transmit (250), to the first apparatus 110, the CSI-RS during the at least one non-active period of the DTX. Correspondingly, the first apparatus 110 may perform (260) measurements of the CSI-RS during the at least one non-active period of the DTX. In an example, the first apparatus 110 may perform further measurements of the CSI-RS on the resource during the at least one non-active period of the DTX based on the request.

In some example embodiments, after the second apparatus 120 may transmit the CSI-RS to the first apparatus 110 during an active period of the DTX before the at least one non-active period of the DTX. Correspondingly, the first apparatus 110 may perform the measurements of the CSI-RS during an active period of the DTX before the at least one non-active period of the DTX.

In some example embodiments, after receiving the request (or report) from the first apparatus 110, the second apparatus 120 may feedback on the planned transmissions in the cell DTX non-active time in terms of how many and when (during the cell DTX non-active time) the CSI-RS will be transmitted and trigger the corresponding transmission.

In some example embodiments, the second apparatus 120 may continue the transmission of the CSI-RS to the first apparatus in a time period after an end of the active period of the DTX and during the at least one non-active period of the DTX. In an example, transmission of CSI-RS continues after the current cell DTX active period ends and during the entire next cell DTX non-active period (irrespective of cell DTX non-activity).

Alternatively, or in addition, the second apparatus 120 may continue the transmission of the CSI-RS in periodicity for the transmission of the CSI-RS during the at least one non-active period of the DTX. In an example, transmission of CSI-RS continues after the current cell DTX active period ends but with a longer periodicity.

Alternatively, or in addition, the second apparatus 120 may continue the transmission of the CSI-RS in a starting time interval within the at least one non-active period of the DTX. In an example, transmission of CSI-RS occurs only during the first y seconds/y CSI-RS periods/y CSI-RS occasions of the subsequent cell DTX non-active period (i.e., transmissions continue after the current cell DTX active period ends for a short interval). y represents any number. In an example, the first apparatus 110 may be configured or allowed to provide a new report and/or request after the y seconds/y CSI-RS periods to indicate a need or no need for further CSI-RS transmissions.

Alternatively, or in addition, the second apparatus 120 may continue the transmission of the CSI-RS in an ending time interval within the at least one non-active period of the DTX. In an example, transmission of CSI-RS occurs only during the last x seconds/x CSI-RS periods of the next cell DTX non-active period (i.e., transmissions occur just before the start of the next cell DTX active period). x represents any number.

In some example embodiments, the second apparatus 120 may transmit, to the first apparatus 110, a configuration of a resource for the transmission of the CSI-RS during the at least one non-active period of the DTX. Accordingly, the first apparatus 110 may perform further measurements of the CSI-RS on the resource during the at least one non-active period of the DTX based on the configuration. In some example embodiments, the resource for the transmission of the CSI-RS during the at least one non-active period of the DTX may be different from a resource for transmission of the CSI-RS during an active period of the DTX. In an example, the second apparatus 120 may configure new CSI-RS resources for BFD to be applied during the subsequent cell DTX non-active period.

In some example embodiments, the transmission of the CSI-RS during the at least one non-active period of the DTX may reuse the resource having configured for the CSI-RS transmission during active periods of the DTX. For example, if the CSI-RS resource has been configured and hence UE is able to measure in active periods, the network may use this resource to transmit the CSI-RS during the non-active period(s) based on the request from the first apparatus 110. In an example, the second apparatus 120 may transmit, during the at least one non-active period of the DTX, the CSI-RS to the first apparatus on a resource configured for transmission of the CSI-RS during an active period of the DTX. In this case, the first apparatus 110 may perform further measurements of the CSI-RS on a resource configured for transmission of the CSI-RS during an active period of the DTX.

In some example embodiments, the second apparatus 120 may transmit, to the first apparatus 110, an indication of a transmission scheme for the transmission of the CSI-RS during the at least one non-active period of the DTX. After the first apparatus 110 receives the indication of the transmission scheme, the first apparatus 110 may perform, based on the transmission scheme, measurements of the CSI-RS during the at least one non-active period of the DTX. In some example embodiments, the second apparatus 120 may transmit, to the first apparatus 110, an indication whether the CSI-RS is to be transmitted during the at least one non-active period of the DTX.

In an example, the second apparatus 120 may decide whether to transmit CSI-RS during (at least part of) the subsequent non-active time and how to transmit them at least partially based on the request/report from the first apparatus 110 and the potential network energy saving. The second apparatus 120 may indicate if/how CSI-RS are transmitted during the cell DTX non-active time by providing a RRC reconfiguration of the CSI-RS/Cell DTX/measurement object, or use a new medium access control (MAC) control element (CE) or physical layer indication to indicate if and how CSI-RS are transmitted. In one example, downlink control information (DCI) used for activation of cell DTX may also indicate the CSI-RS transmission scheme. In an example, the transmission scheme may comprise transmission through the non-active period of DTX, transmission with a periodicity different from a periodicity for the active period of DTX, transmission in first y seconds of the non-active period of DTX, and/or the like.

Accordingly, the first apparatus 110 may perform further measurements of the CSI-RS during non-active periods, unless the second apparatus 120 has indicated the request is denied or that CSI-RS will not be transmitted.

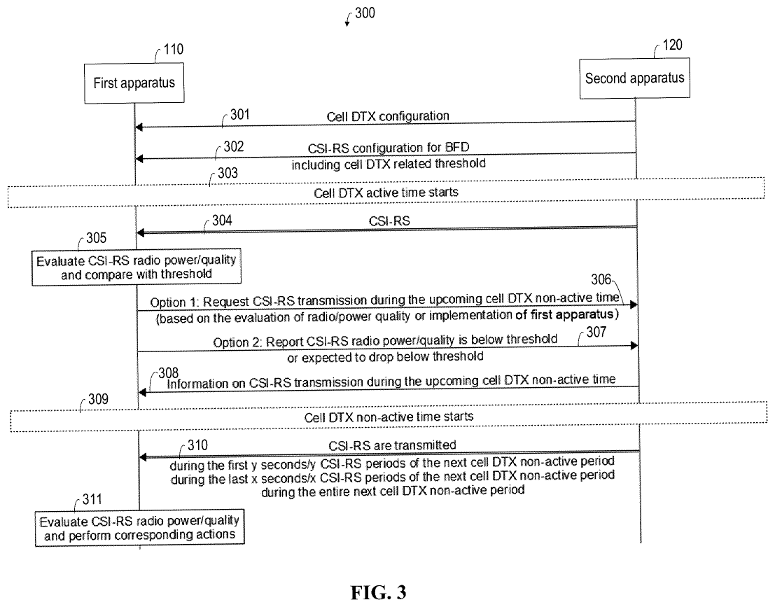

FIG. 3 shows a signaling diagram of a process 300 for CSI-RS transmission according to some example embodiment of the present disclosure.

As shown in FIG. 3, at 301, the second apparatus 120 may transmit a cell DTX configuration to the first apparatus 110. For example, the second apparatus 120 may configure the cell DTX pattern and the time when it will be activated. At 302, the second apparatus 120 may transmit a CSI-RS configuration for BFD to the first apparatus 110, including cell DTX related threshold. At 303, cell DTX active time may start. At 304, the second apparatus 120 may transmit a periodic CSI-RS to the first apparatus 110 during the cell DTX active time, and by default no CSI-RS are transmitted during non-active time. Finally, the second apparatus 120 may configure thresholds related to the beam management measurements.

At 305, the first apparatus 110 may evaluate the (configured) threshold(s) (e.g., Q_{out_LR_CSI-RS}), or the threshold Q_{out_LR_CSI-RS} with an offset configured for the second apparatus 120, or a new threshold configured for the second apparatus 120, to be evaluated based on CSI-RS measured during the cell DTX active time.

At steps 306, as an option, if the radio quality value is not within/above the threshold(s), the first apparatus 110 may request CSI-RS transmission (option 1) to the second apparatus 120 during the upcoming cell DTX non-active time based on the evaluation of radio/power quality or implementation of the first apparatus 110. In an example, the first apparatus 110 may request CSI-RS transmission prior to the end of a cell DTX active time by sending e.g. UCI using a physical uplink control channel or a PUSCH, a MAC CE or RRC signaling. In an example, the first apparatus 110 may request CSI-RS transmission at the beginning of a cell DTX inactive time by sending e.g., a physical random access channel (PRACH).

At 307, as another option, if the radio quality value is not within/above the threshold(s), the first apparatus 110 may report the measurement results (option 2) to the second apparatus 120. In an example, the first apparatus 110 may report that CSI-RS radio power/quality is below threshold (e.g., in a time window). In an example, the report may be based on RRC signaling. In an example, the new report may be sent along with a (periodic) CSI-RSRP reporting.

At 308, the second apparatus 120 may transmit information on CSI-RS to the first apparatus 110 during the upcoming cell DTX non-active time. At 309, the cell DTX non-active time may start. At 310, the second apparatus 120 may transmit CSI-RS to the first apparatus 110 during the first y seconds/y CSI-RS periods of the next cell DTX non-active period, during the last x seconds/x CSI-RS periods of the next cell DTX non-active period, and/or during the entire next cell DTX non-active period.

At 311, the first apparatus 110 may evaluate CSI-RS radio power/quality and perform corresponding actions.

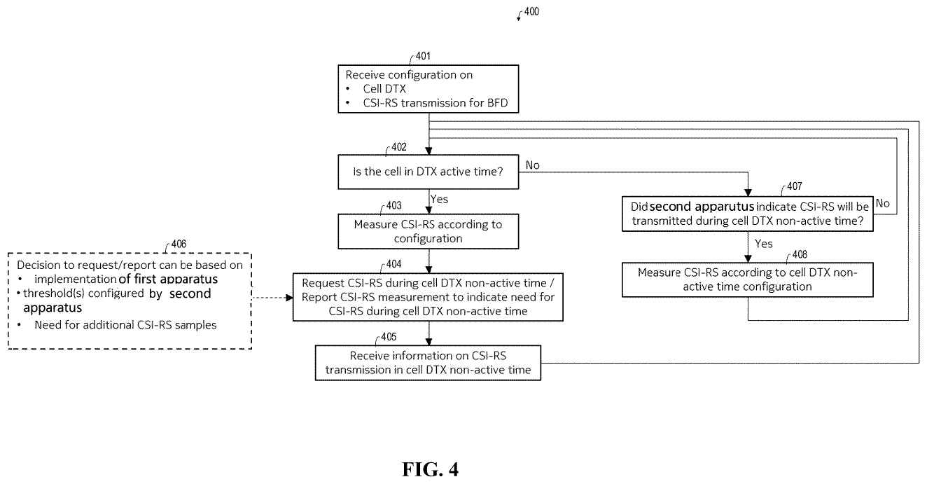

FIG. 4 shows a flow chart of a process 400 implemented at the first apparatus 110 according to some example embodiments of the present disclosure.

As shown in FIG. 4, at block 401, the first apparatus 110 may receive a configuration on cell DTX and a CSI-RS transmission for BFD. At block 402, the first apparatus 110 may determine if the cell is in DTX active time. If yes, the process 400 proceeds to block 403, and if not, the process 400 proceeds to block 407. At block 403, the first apparatus 110 may measure the CSI-RS according to the configuration. At block 404, the first apparatus 110 may request the CSI-RS during cell DTX non-active time or report CSI-RS measurement to indicate a need for CSI-RS during cell DTX non-active time.

At block 405, the first apparatus 110 may receive information on a CSI-RS transmission in cell DTX non-active time. As an option, at block 406, the first apparatus 110 may decide to request or report based on its own implementation, threshold(s) configured by the second apparatus 120 or the network, and/or a need for addition CSI-RS samples.

At block 407, the first apparatus 110 may determine if the second apparatus 120 indicated the CSI-RS will be transmitted during cell DTX non-active time. If yes, the process 400 proceeds to block 408, and if not, the process 400 proceeds back to block 402.

At block 408, the first apparatus 110 may measure CSI-RS according to cell DTX non-active time configuration. Then, the process 400 returns to block 402.

### Example Methods

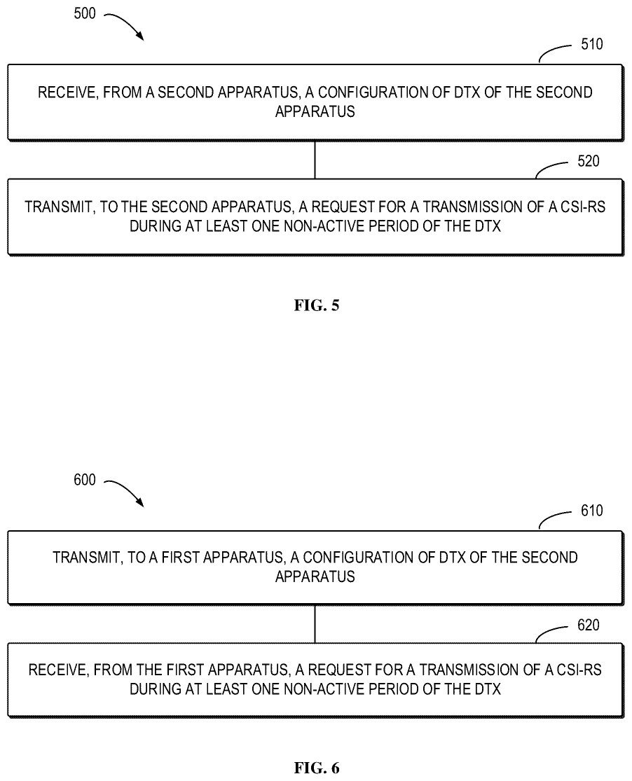

FIG. 5 shows a flowchart of an example method 500 implemented at a first apparatus in accordance with some example embodiments of the present disclosure. For the purpose of discussion, the method 500 will be described from the perspective of the first apparatus 110 in FIG. 1.

At block 510, the first apparatus 110 receives, from the second apparatus 120, a configuration of DTX of the second apparatus 120. At block 520, the first apparatus 110 transmits, to the second apparatus 120, a request for a transmission of a CSI-RS during at least one non-active period of the DTX.

In some example embodiments, the method 500 further comprises: determining, based on measurements of the CSI-RS, that at least one condition is met; based on the at least one condition being met, determining that the transmission of the CSI-RS is needed during the at least one non-active period of the DTX; and based on determining that the transmission of the CSI-RS is needed, transmitting, to the second apparatus 120, the request for the transmission of the CSI-RS during the at least one non-active period of the DTX.

In some example embodiments, the at least one condition comprises at least one of: a condition that a measured quality metric of the CSI-RS is equal to or less than a threshold quality metric, a condition that a quality metric of the CSI-RS is equal to or less than a threshold quality metric within a time window, a condition that a radio link quality on at least one of a plurality of resources for the CSI-RS is equal to or less than a threshold quality, a condition that an additional measurement sample is required for the measurements of the CSI-RS, or a condition that a beam failure instance indication is sent to high layers.

In some example embodiments, the request includes at least one of: a measurement status of BFD on a plurality of resources for the CSI-RS, an indication of at least one resource for the transmission of the CSI-RS during the at least one non-active period of the DTX, a time period for the transmission of the CSI-RS during the at least one non-active period of the DTX, a number of CSI-RSs to be transmitted during the at least one non-active period of the DTX, a number of non-active periods or DTX periodicity for the transmission of the CSI-RS during the at least one non-active period of the DTX, or an indication that the transmission of the CSI-RS during the at least one non-active period of the DTX is needed.

In some example embodiments, the method 500 further comprises: performing the measurements of the CSI-RS during an active period of the DTX before the at least one non-active period of the DTX.

In some example embodiments, the method 500 further comprises: performing further measurements of the CSI-RS in at least one of: a time period after an end of the active period of the DTX and during the at least one non-active period of the DTX, periodicity for the transmission of the CSI-RS during the at least one non-active period of the DTX, a starting time interval within the at least one non-active period of the DTX, or an ending time interval within the at least one non-active period of the DTX.

In some example embodiments, the method 500 further comprises: performing further measurements of the CSI-RS on the resource during the at least one non-active period of the DTX based on the request.

In some example embodiments, the method 500 further comprises: receiving, from the second apparatus 120, a configuration of a resource for the transmission of the CSI-RS during the at least one non-active period of the DTX; and performing further measurements of the CSI-RS on the resource during the at least one non-active period of the DTX.

In some example embodiments, the method 500 further comprises: performing further measurements of the CSI-RS during the at least one non-active period of the DTX on a resource configured for transmission of the CSI-RS during an active period of the DTX.

In some example embodiments, the method 500 further comprises: receiving, from the second apparatus 120, an indication of a transmission scheme for the transmission of the CSI-RS during the at least one non-active period of the DTX; and performing, based on the transmission scheme, measurements of the CSI-RS during the at least one non-active period of the DTX.

In some example embodiments, the method 500 further comprises: receiving, from the second apparatus 120, an indication whether the CSI-RS is to be transmitted during the at least one non-active period of the DTX.

In some example embodiments, the first apparatus 110 may transmit, to the second apparatus 120, the request during an active period of discontinuous reception (DRX) of the second apparatus 120.

In some example embodiments, the DTX is configured for a secondary cell of the second apparatus 120.

FIG. 6 shows a flowchart of an example method 600 implemented at a second apparatus in accordance with some example embodiments of the present disclosure. For the purpose of discussion, the method 600 will be described from the perspective of the second apparatus 120 in FIG. 1.

At block 610, the second apparatus 120 transmits, to the first apparatus 110, a configuration of DTX of the second apparatus 120. At block 620, the second apparatus 120 receives, from the first apparatus 110, a request for a transmission of a CSI-RS during at least one non-active period of the DTX.

In some example embodiments, the method 600 further comprises: transmitting, to the first apparatus, the CSI-RS during the at least one non-active period of the DTX.

In some example embodiments, the request includes at least one of: a measurement status of BFD on a plurality of resources for the CSI-RS, an indication of at least one resource for the transmission of the CSI-RS during the at least one non-active period of the DTX, a time period for the transmission of the CSI-RS during the at least one non-active period of the DTX, a number of CSI-RSs to be transmitted during the at least one non-active period of the DTX, a number of non-active periods or DTX periodicity for the transmission of the CSI-RS during the at least one non-active period of the DTX, or an indication that the transmission of the CSI-RS during the at least one non-active period of the DTX is needed.

In some example embodiments, the method 600 further comprises: transmitting the CSI-RS to the first apparatus during an active period of the DTX before the at least one non-active period of the DTX.

In some example embodiments, the method 600 further comprises: continuing the transmission of the CSI-RS to the first apparatus in at least one of: a time period after an end of the active period of the DTX and during the at least one non-active period of the DTX, periodicity for the transmission of the CSI-RS during the at least one non-active period of the DTX, a starting time interval within the at least one non-active period of the DTX, or an ending time interval within the at least one non-active period of the DTX.

In some example embodiments, the method 600 further comprises: transmitting, to the first apparatus, a configuration of a resource for the transmission of the CSI-RS during the at least one non-active period of the DTX.

In some example embodiments, the method 600 further comprises: transmitting, during the at least one non-active period of the DTX, the CSI-RS to the first apparatus on a resource configured for transmission of the CSI-RS during an active period of the DTX.

In some example embodiments, the method 600 further comprises: transmitting, to the first apparatus, an indication of a transmission scheme for the transmission of the CSI-RS during the at least one non-active period of the DTX.

In some example embodiments, the method 600 further comprises: transmitting, to the first apparatus, an indication whether the CSI-RS is to be transmitted during the at least one non-active period of the DTX.

In some example embodiments, the second apparatus 120 may receive, from the first apparatus 110, the request during an active period of DRX of the second apparatus 120.

In some example embodiments, the DTX is configured for a secondary cell.

### Example Apparatus, Device and Medium

In some example embodiments, a first apparatus capable of performing the method 500 (for example, the first apparatus 110 in FIG. 1) may comprise means for performing the respective operations of the method 500. The means may be implemented in any suitable form. For example, the means may be implemented in a circuitry or software module. The first apparatus may be implemented as or included in the first apparatus 110 in FIG. 1.

In some example embodiments, the first apparatus comprises means for receiving, from a second apparatus, a configuration of discontinuous transmission (DTX) of the second apparatus; and means for transmitting, to the second apparatus, a request for a transmission of a channel state information reference signal (CSI-RS) during at least one non-active period of the DTX.

In some example embodiments, the first apparatus further comprises: means for determining, based on measurements of the CSI-RS, that at least one condition is met; means for based on the at least one condition being met, determining that the transmission of the CSI-RS is needed during the at least one non-active period of the DTX; and means for based on determining that the transmission of the CSI-RS is needed, transmitting, to the second apparatus, the request for the transmission of the CSI-RS during the at least one non-active period of the DTX.

In some example embodiments, the at least one condition comprises at least one of: a condition that a measured quality metric of the CSI-RS is equal to or less than a threshold quality metric, a condition that a quality metric of the CSI-RS is equal to or less than a threshold quality metric within a time window, a condition that a radio link quality on at least one of a plurality of resources for the CSI-RS is equal to or less than a threshold quality, a condition that an additional measurement sample is required for the measurements of the CSI-RS, or a condition that a beam failure instance indication is sent to high layers.

In some example embodiments, the request includes at least one of: a measurement status of beam failure detection (BFD) on a plurality of resources for the CSI-RS, an indication of at least one resource for the transmission of the CSI-RS during the at least one non-active period of the DTX, a time period for the transmission of the CSI-RS during the at least one non-active period of the DTX, a number of CSI-RSs to be transmitted during the at least one non-active period of the DTX, a number of non-active periods or DTX periodicity for the transmission of the CSI-RS during the at least one non-active period of the DTX, or an indication that the transmission of the CSI-RS during the at least one non-active period of the DTX is needed.

In some example embodiments, the first apparatus further comprises: means for performing the measurements of the CSI-RS during an active period of the DTX before the at least one non-active period of the DTX.

In some example embodiments, the first apparatus further comprises: means for performing further measurements of the CSI-RS in at least one of: a time period after an end of the active period of the DTX and during the at least one non-active period of the DTX, means for periodicity for the transmission of the CSI-RS during the at least one non-active period of the DTX, a starting time interval within the at least one non-active period of the DTX, or an ending time interval within the at least one non-active period of the DTX.

In some example embodiments, the first apparatus further comprises: means for performing further measurements of the CSI-RS on the resource during the at least one non-active period of the DTX based on the request.

In some example embodiments, the first apparatus further comprises: means for receiving, from the second apparatus, a configuration of a resource for the transmission of the CSI-RS during the at least one non-active period of the DTX; and means for performing further measurements of the CSI-RS on the resource during the at least one non-active period of the DTX.

In some example embodiments, the first apparatus further comprises: means for performing further measurements of the CSI-RS during the at least one non-active period of the DTX on a resource configured for transmission of the CSI-RS during an active period of the DTX.

In some example embodiments, the first apparatus further comprises: means for receiving, from the second apparatus, an indication of a transmission scheme for the transmission of the CSI-RS during the at least one non-active period of the DTX; and means for performing, based on the transmission scheme, measurements of the CSI-RS during the at least one non-active period of the DTX.

In some example embodiments, the first apparatus further comprises: means for receiving, from the second apparatus, an indication whether the CSI-RS is to be transmitted during the at least one non-active period of the DTX.

In some example embodiments, cause the first apparatus to: means for transmitting, to the second apparatus, the request during an active period of discontinuous reception (DRX) of the second apparatus.

In some example embodiments, the DTX is configured for a secondary cell of the second apparatus.

In some example embodiments, the first apparatus further comprises means for performing other operations in some example embodiments of the method 500 or the first apparatus 110. In some example embodiments, the means comprises at least one processor; and at least one memory storing instructions that, when executed by the at least one processor, cause the performance of the first apparatus.

In some example embodiments, a second apparatus capable of performing the method 600 (for example, the second apparatus 120 in FIG. 1) may comprise means for performing the respective operations of the method 600. The means may be implemented in any suitable form. For example, the means may be implemented in a circuitry or software module. The second apparatus may be implemented as or included in the second apparatus 120 in FIG. 1.

In some example embodiments, the second apparatus comprises means for transmitting, to a first apparatus, a configuration of discontinuous transmission (DTX) of the second apparatus; and means for receiving, from the first apparatus, a request for a transmission of a channel state information reference signal (CSI-RS) during at least one non-active period of the DTX.

In some example embodiments, the second apparatus further comprises: means for transmitting, to the first apparatus, the CSI-RS during the at least one non-active period of the DTX.

In some example embodiments, the request includes at least one of: a measurement status of beam failure detection (BFD) on a plurality of resources for the CSI-RS, an indication of at least one resource for the transmission of the CSI-RS during the at least one non-active period of the DTX, a time period for the transmission of the CSI-RS during the at least one non-active period of the DTX, a number of CSI-RSs to be transmitted during the at least one non-active period of the DTX, a number of non-active periods or DTX periodicity for the transmission of the CSI-RS during the at least one non-active period of the DTX, or an indication that the transmission of the CSI-RS during the at least one non-active period of the DTX is needed.

In some example embodiments, the second apparatus further comprises: means for transmitting the CSI-RS to the first apparatus during an active period of the DTX before the at least one non-active period of the DTX.

In some example embodiments, the second apparatus further comprises: means for continuing the transmission of the CSI-RS to the first apparatus in at least one of: a time period after an end of the active period of the DTX and during the at least one non-active period of the DTX, periodicity for the transmission of the CSI-RS during the at least one non-active period of the DTX, a starting time interval within the at least one non-active period of the DTX, or an ending time interval within the at least one non-active period of the DTX.

In some example embodiments, the second apparatus further comprises: means for transmitting, to the first apparatus, a configuration of a resource for the transmission of the CSI-RS during the at least one non-active period of the DTX.

In some example embodiments, the second apparatus further comprises: means for transmitting, during the at least one non-active period of the DTX, the CSI-RS to the first apparatus on a resource configured for transmission of the CSI-RS during an active period of the DTX.

In some example embodiments, the second apparatus further comprises: means for transmitting, to the first apparatus, an indication of a transmission scheme for the transmission of the CSI-RS during the at least one non-active period of the DTX.

In some example embodiments, the second apparatus further comprises: means for transmitting, to the first apparatus, an indication whether the CSI-RS is to be transmitted during the at least one non-active period of the DTX.

In some example embodiments, cause the second apparatus to: means for receiving, from the first apparatus, the request during an active period of discontinuous reception (DRX) of the second apparatus.

In some example embodiments, the DTX is configured for a secondary cell.

In some example embodiments, the second apparatus further comprises means for performing other operations in some example embodiments of the method 600 or the second apparatus 120. In some example embodiments, the means comprises at least one processor; and at least one memory storing instructions that, when executed by the at least one processor, cause the performance of the second apparatus.

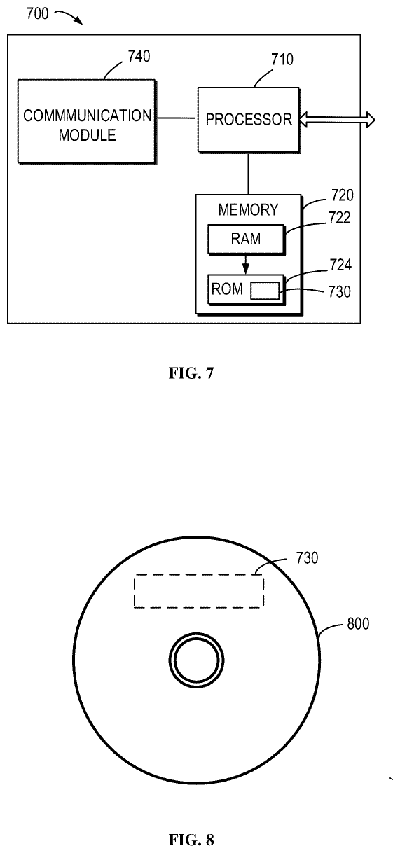

FIG. 7 is a simplified block diagram of a device 700 that is suitable for implementing example embodiments of the present disclosure. The device 700 may be provided to implement a communication device, for example, the first apparatus 110 or the second apparatus 120 as shown in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The instructions of the program 730 may include instructions for performing operations/acts of some example embodiments of the present disclosure. The program 730 may be stored in the memory, e.g., the ROM 724. The processor 710 may perform any suitable actions and processing by loading the program 730 into the RAM 722.

The example embodiments of the present disclosure may be implemented by means of the program 730 so that the device 700 may perform any process of the disclosure as discussed with reference to FIG. 1 to FIG. 6. The example embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 8 shows an example of the computer readable medium 800 which may be in form of CD, DVD or other optical storage disk. The computer readable medium 800 has the program 730 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-29. (canceled)

30. A first apparatus comprising:
at least one processor; and
at least one memory storing instructions that, when executed by the at least one processor, cause the first apparatus at least to:
receive, from a second apparatus, a configuration of discontinuous transmission (DTX) of the second apparatus;
transmit, to the second apparatus, a request for a transmission of a channel state information reference signal (CSI-RS) during at least one non-active period of the DTX;
receive, from the second apparatus, an indication of a transmission scheme for the transmission of the CSI-RS during at least one non-active period of the DTX; and
perform, based on the transmission scheme, measurements of the CSI-RS during the at least one non-active period of the DTX;
determine, based on the measurements of the CSI-RS, that a plurality of conditions have been met, wherein the plurality of conditions comprise the following: a first condition that a first measured quality metric of the CSI-RS is equal to or less than a first threshold quality metric, a second condition that a second quality metric of the CSI-RS is equal to or less than a second threshold quality metric within a time window, a third condition that a radio link quality on at least one of a plurality of resources for the CSI-RS is equal to or less than a third threshold quality, a fourth condition that an additional measurement sample is required for the measurements of the CSI-RS, and a fifth condition that a beam failure instance indication is sent to high layers;
based on the plurality of conditions being met, determine that the transmission of the CSI-RS is needed during the at least one non-active period of the DTX;
based on determining that the transmission of the CSI-RS is needed during the at least one non-active period of the DTX, transmit, to the second apparatus, the request for the transmission of the CSI-RS during the at least one non-active period of the DTX;
upon receipt of the CSI-RS from the second apparatus, evaluate CSI-RS radio power and quality; and
perform corresponding actions based on the evaluating.

31. The first apparatus of claim 30, wherein the request includes the following:
a measurement status of beam failure detection (BFD) on a plurality of resources for the CSI-RS,
an indication of at least one resource for the transmission of the CSI-RS during the at least one non-active period of the DTX,
a time period for the transmission of the CSI-RS during the at least one non-active period of the DTX,
a number of CSI-RSs to be transmitted during the at least one non-active period of the DTX,
a number of non-active periods or DTX periodicity for the transmission of the CSI-RS during the at least one non-active period of the DTX, and
an indication that the transmission of the CSI-RS during the at least one non-active period of the DTX is needed.

32. The first apparatus of claim 31, wherein the at least one memory and the at least one processor further cause the first apparatus to:
perform further measurements of the CSI-RS in the following:
a time period after an end of the active period of the DTX and during the at least one non-active period of the DTX,
periodicity for the transmission of the CSI-RS during the at least one non-active period of the DTX,
a starting time interval within the at least one non-active period of the DTX, or
an ending time interval within the at least one non-active period of the DTX.

33. The first apparatus of claim 32, wherein the at least one memory and the at least one processor further cause the first apparatus to:
perform further measurements of the CSI-RS on a resource during the at least one non-active period of the DTX based on the request.

34. The first apparatus of claim 33, wherein the at least one memory and the at least one processor further cause the first apparatus to:
receive, from the second apparatus, a configuration of a resource for the transmission of the CSI-RS during the at least one non-active period of the DTX; and
based on the configuration of the resource, perform the further measurements of the CSI-RS on the resource during the at least one non-active period of the DTX.

35. The first apparatus of claim 34, wherein the at least one memory and the at least one processor further cause the first apparatus to:
perform additional measurements of the CSI-RS during the at least one non-active period of the DTX on a resource configured for transmission of the CSI-RS during an active period of the DTX.

36. The first apparatus of claim 35, wherein the at least one memory and the at least one processor cause the first apparatus to:
transmit, to the second apparatus, the request during an active period of discontinuous reception (DRX) of the second apparatus.

37. The first apparatus of claim 36, wherein the DTX is configured for a secondary cell of the second apparatus.

38. A system comprising:
a first apparatus:
at least one processor; and
at least one memory storing instructions that, when executed by the at least one processor, cause the first apparatus at least to:
receive, from a second apparatus, a configuration of discontinuous transmission (DTX) of the second apparatus;
transmit, to the second apparatus, a request for a transmission of a channel state information reference signal (CSI-RS) during at least one non-active period of the DTX;
receive, from the second apparatus, an indication of a transmission scheme for the transmission of the CSI-RS during at least one non-active period of the DTX; and
perform, based on the transmission scheme, measurements of the CSI-RS during the at least one non-active period of the DTX;
determine, based on the measurements of the CSI-RS, that a plurality of conditions have been met, wherein the plurality of conditions comprise the following: a first condition that a first measured quality metric of the CSI-RS is equal to or less than a first threshold quality metric, a second condition that a second quality metric of the CSI-RS is equal to or less than a second threshold quality metric within a time window, a third condition that a radio link quality on at least one of a plurality of resources for the CSI-RS is equal to or less than a third threshold quality, a fourth condition that an additional measurement sample is required for the measurements of the CSI-RS, and a fifth condition that a beam failure instance indication is sent to high layers;
based on the plurality of conditions being met, determine that the transmission of the CSI-RS is needed during the at least one non-active period of the DTX;
based on determining that the transmission of the CSI-RS is needed during the at least one non-active period of the DTX, transmit, to the second apparatus, the request for the transmission of the CSI-RS during the at least one non-active period of the DTX;
upon receipt of the CSI-RS from the second apparatus, evaluate CSI-RS radio power and quality; and
perform corresponding actions based on the evaluating.

39. The system of claim 38, wherein the request includes the following:
a measurement status of beam failure detection (BFD) on a plurality of resources for the CSI-RS,
an indication of at least one resource for the transmission of the CSI-RS during the at least one non-active period of the DTX,
a time period for the transmission of the CSI-RS during the at least one non-active period of the DTX,
a number of CSI-RSs to be transmitted during the at least one non-active period of the DTX,
a number of non-active periods or DTX periodicity for the transmission of the CSI-RS during the at least one non-active period of the DTX, and
an indication that the transmission of the CSI-RS during the at least one non-active period of the DTX is needed.

40. The system of claim 39, wherein the at least one memory and the at least one processor further cause the first apparatus to:
perform further measurements of the CSI-RS in the following:
a time period after an end of the active period of the DTX and during the at least one non-active period of the DTX,
periodicity for the transmission of the CSI-RS during the at least one non-active period of the DTX,
a starting time interval within the at least one non-active period of the DTX, or
an ending time interval within the at least one non-active period of the DTX.

41. The system of claim 40, wherein the at least one memory and the at least one processor further cause the first apparatus to:
perform further measurements of the CSI-RS on a resource during the at least one non-active period of the DTX based on the request.

42. The system of claim 41, wherein the at least one memory and the at least one processor further cause the first apparatus to:
receive, from the second apparatus, a configuration of a resource for the transmission of the CSI-RS during the at least one non-active period of the DTX; and
based on the configuration of the resource, perform the further measurements of the CSI-RS on the resource during the at least one non-active period of the DTX.

43. The system of claim 42, wherein the at least one memory and the at least one processor further cause the first apparatus to:
perform additional measurements of the CSI-RS during the at least one non-active period of the DTX on a resource configured for transmission of the CSI-RS during an active period of the DTX.

44. The system of claim 43, wherein the at least one memory and the at least one processor cause the first apparatus to:
transmit, to the second apparatus, the request during an active period of discontinuous reception (DRX) of the second apparatus.

45. The system of claim 44, wherein the DTX is configured for a secondary cell of the second apparatus.

46. A method comprising:
receiving, by a first apparatus from a second apparatus, a configuration of discontinuous transmission (DTX) of the second apparatus;
transmitting, to the second apparatus, a request for a transmission of a channel state information reference signal (CSI-RS) during at least one non-active period of the DTX;
receiving, from the second apparatus, an indication of a transmission scheme for the transmission of the CSI-RS during at least one non-active period of the DTX; and
performing, based on the transmission scheme, measurements of the CSI-RS during the at least one non-active period of the DTX;
determining, based on the measurements of the CSI-RS, that a plurality of conditions have been met, wherein the plurality of conditions comprise the following: a first condition that a first measured quality metric of the CSI-RS is equal to or less than a first threshold quality metric, a second condition that a second quality metric of the CSI-RS is equal to or less than a second threshold quality metric within a time window, a third condition that a radio link quality on at least one of a plurality of resources for the CSI-RS is equal to or less than a third threshold quality, a fourth condition that an additional measurement sample is required for the measurements of the CSI-RS, and a fifth condition that a beam failure instance indication is sent to high layers;
based on the plurality of conditions being met, determining that the transmission of the CSI-RS is needed during the at least one non-active period of the DTX;
based on determining that the transmission of the CSI-RS is needed during the at least one non-active period of the DTX, transmitting, to the second apparatus, the request for the transmission of the CSI-RS during the at least one non-active period of the DTX;
upon receipt of the CSI-RS from the second apparatus, evaluating CSI-RS radio power and quality; and
performing corresponding actions based on the evaluating.

47. The method of claim 46, wherein the request includes the following:
a measurement status of beam failure detection (BFD) on a plurality of resources for the CSI-RS,
an indication of at least one resource for the transmission of the CSI-RS during the at least one non-active period of the DTX,
a time period for the transmission of the CSI-RS during the at least one non-active period of the DTX,
a number of CSI-RSs to be transmitted during the at least one non-active period of the DTX,
a number of non-active periods or DTX periodicity for the transmission of the CSI-RS during the at least one non-active period of the DTX, and
an indication that the transmission of the CSI-RS during the at least one non-active period of the DTX is needed.

48. The method of claim 47, further comprising:
performing further measurements of the CSI-RS in the following:
a time period after an end of the active period of the DTX and during the at least one non-active period of the DTX,
periodicity for the transmission of the CSI-RS during the at least one non-active period of the DTX,
a starting time interval within the at least one non-active period of the DTX, or
an ending time interval within the at least one non-active period of the DTX.

49. The method of claim 48, wherein the DTX is configured for a secondary cell of the second apparatus.
